(19) United States
(12) Patent Application Publication
(10) Pub. No.: US 2011/0039992 A1
(43) Pub. Date: Feb. 17, 2011

(54) Method of Improving Stability Of Organopolysiloxane And An Organopolysiloxane Mixture

(76) Inventor: Masakazu Irie, Chiba (JP)

Correspondence Address: HOWARD & HOWARD ATTORNEYS PLLC, 450 West Fourth Street, Royal Oak, MI, 48067, US

(21) Appl. No.: 12/521,328

(22) PCT Filed: Dec. 20, 2007
(86) PCT No.: PCT/JP2007/075237

§ 371 Date: Oct. 27, 2010

(30) Foreign Application Priority Data
Dec. 27, 2006 (JP) 2006-352470

(51) Int. Cl. C08K 5/3492; C08K 5/24; C08K 5/092; C08K 5/3472; C08K 5/17

(52) U.S. Cl. 524/100; 524/189; 524/321; 524/106; 524/186

(57) ABSTRACT

A method for improving thermal stability of an organopolysiloxane characterized by compounding an organopolysiloxane (A), which was polymerized with participation of an alkali-metal catalyst, with a metal deactivater (B); and an organopolysiloxane mixture composed of an organopolysiloxane (A) characterized by compounding organopolysiloxane (A), which was polymerized with participation of an alkali-metal catalyst, with a metal deactivater (B) used in the amount of 0.02 to 1 part by mass per 10 ppm of the alkali metal contained in component (A).

### TECHNICAL FIELD

The present invention relates to a method of improving thermal stability of an organopolysiloxane and to an organopolysiloxane mixture having improved thermal stability.

### BACKGROUND ART

An organopolysiloxane can be produced by equilibrium polymerization of a linear or cyclic organopolysiloxane having low molecular weight, typically, in the presence of an alkali-metal catalyst (see Japanese Examined Patent Application Publication (hereinafter referred to as “Kokoku” H08-22920 (equivalent to U.S. Pat. No. 4,719,276) and Kokoku S47-44040). The organopolysiloxane produced by the above method contains a low-molecular-weight cyclic organopolysiloxane, but since the use of an organopolysiloxane as such may be associated with some problems, the aforementioned low-molecular-weight component is removed by thermal distillation. In particular, in order to use the aforementioned organopolysiloxane in the structure of electric and electronic devices, the organopolysiloxane has to be preliminarily cleared from the low-molecular-weight components, but since the aforementioned thermal distillation is carried out under severe conditions, the alkali-metal catalyst, which is a polymerization catalyst, may not be sufficiently neutralized. This may cause depolymerization of the organopolysiloxane and impair efficiency of removal of the low-molecular-weight components. Furthermore, if the alkali-metal catalyst contained in the organopolysiloxane is not sufficiently neutralized, this may decrease heat-resistant properties and storage stability of silicone products manufactured from the aforementioned organopolysiloxane as a starting material. The above problem is in particular critical when the organopolysiloxane has high viscosity and it becomes difficult to remove neutralization salts of the alkali-metal catalyst by filtration.

As described in U.S. Pat. No. 4,250,290, it was proposed to solve the above problem by subjecting a cyclic dimethylsiloxane monomer to equilibrium polymerization in the presence of a potassium-silanolate catalyst, and then to neutralize the product with silyl phosphate. A disadvantage of this method is that the presence of phosphoric acid causes corrosion of the polymerization equipment.

### DISCLOSURE OF INVENTION

The inventor herein proposes a method of improving thermal stability of the organopolysiloxane by combining the organopolysiloxane, which was polymerized with the use of an alkali-metal catalyst, with a metal deactivater.

The method of the invention for improving thermal stability of an organopolysiloxane consists of compounding a metal deactivater (B) with an organopolysiloxane (A) polymerized with the use of an alkali metal catalyst. It is recommended to use the metal deactivater in an amount of 0.02 to 1 part by mass per 10 ppm of the alkali metal contained in the aforementioned organopolysiloxane. It is also recommended that the content of alkali metal in the aforementioned organopolysiloxane be in the range of 1 to 500 ppm.

Furthermore, the organopolysiloxane mixture of the present invention comprises an organopolysiloxane (A) polymerized with the use of an alkali metal catalyst and a metal deactivater (B) (which is used in the amount of 0.02 to 1 part by mass per 10 ppm of the alkali metal contained in component (A)).

The alkali-metal catalyst may comprise a potassium silanolate or a potassium hydroxide, while the metal deactivater may be a compound selected from a hydrazide-based compound, an aminotriazole-based compound, or a triazine-based compound.

Since the method of the invention for stabilization of the organopolysiloxane involves introduction of metal deactivater (B) that deactivates the catalytic residue contained in component (A), it becomes possible to increase the decomposition temperature of the organopolysiloxane polymerized with the used of an alkali-metal catalyst, and this, in turn, improves thermal stability of the organopolysiloxane. Furthermore, since the mixture composed of the organopolysiloxane polymerized with the use of the alkali-metal catalyst and metal deactivater (B) has the increased thermal-decomposition temperature, one can expect that the mixture as such may improve storage stability and heat-resistant properties of silicone products which are manufactured by using the aforementioned composition as a starting material.

### BEST MODE FOR CARRYING OUT THE INVENTION

Organopolysiloxane (A) used in the present invention is produced in a conventional manner by subjecting a linear or cyclic organopolysiloxane to equilibrium polymerization in the presence of an alkali-metal catalyst. The alkali-metal catalyst may be represented by potassium hydroxide, sodium hydroxide, cesium hydroxide, or a similar alkali-metal hydroxide; or potassium silanolate, sodium silanolate, or a similar alkali-metal silanolate. Among these, most preferable from the viewpoint of catalytic activity is potassium silanolate. In the linear or cyclic organopolysiloxane, the alkali-metal catalyst is normally contained in the amount such that concentration of alkali metal is maintained in the range of 1 to 500 ppm.

Organopolysiloxane (A) is represented by the following average unit formula: RₐSiO_{(4-a)/2}, where R designates a substituted or non-substituted univalent hydrocarbon group having 1 to 10 carbon atoms, and “a” is a number ranging from 1.95 to 2.05. The monovalent hydrocarbon group designated by R may be represented by methyl, ethyl, propyl, butyl, pentyl, hexyl, octyl, decyl, dodecyl, or a similar alkyl group; vinyl, propenyl, butenyl, hexenyl, or a similar alkenyl group; phenyl, tolyl, or a similar aryl group; 13-phenylethyl, or a similar aralkyl group; 3,3,3-trifluoropropyl, trichloropropyl, or a similar halogenated alkyl group, etc. Among these, preferable are the methyl group, the phenyl, and the 3,3,3-fluoropropyl group, and most preferable is the methyl group which facilitates synthesis. Furthermore, in order to facilitate the use of the curable composition, it is preferable to contain a small amount of vinyl groups. A small amount of hydroxyl groups can be contained in molecular terminals. The repetition number of average units of organopolysiloxane (A) is normally in the range of 2 to 100,000. There are no special restrictions with regard to the molecular structure, and the molecular structure can be linear, partially branched linear, or net-like structure, but the linear or partially branched linear molecular structure is preferable.

Specific examples of component (A) are the following: a dimethylpolysiloxane capped by trimethylsiloxy groups; a copolymer of a methylvinylsiloxane and a dimethylsiloxane capped by trimethylsiloxy groups; a copolymer of a methylphenylsiloxane and a dimethylsiloxane capped by trimethylsiloxy groups; a dimethylpolysiloxane capped with silanol groups; a copolymer of methylvinylsiloxane and a dimethylsiloxane capped silanol groups, or a copolymer of a methylphenylsiloxane and a dimethylsiloxane capped with silanol groups; a dimethylpolysiloxane capped by dimethylvinylsiloxy groups; a copolymer of a methylvinylsiloxane and a dimethylsiloxane capped by dimethylvinylsiloxy groups; a copolymer of a methylphenylsiloxane and a dimethylsiloxane capped by dimethylvinylsiloxy groups.

When the number-average-molecular weight of component (A) recalculated to polystyrene and measured by gel-permeation chromatography (GPC) is in the range of 100,000 to 1,000,000, removal of neutralization salts of the alkali-metal catalyst by filtering presents a problem. Therefore, the increase in heat-resistant properties provided by the method of the invention produces a desired effect. Another effect of the method of the invention is that the method eliminates the need for removal of the neutralization salts of the aforementioned alkali-metal catalyst by filtering.

Metal deactivater (B) is an indispensable component of the composition of the invention that is used to increase the thermal-decomposition temperature of organopolysiloxane (A) and thus for improving thermal stability of the composition. Component (B) may comprise a hydrazide-based compound, an oxalic-acid-based compound, an aminotriazole-based compound, a benzotriazole-based compound, a triazine-based compound, a salicylidene-amine-based compound, or a similar known metal deactivater. Such agents are commercially produced by Ciba Specialty Chemicals Co., Ltd., Adeka Co., Ltd., Sochtech S.A., etc. Most preferable are the hydrazide-based compound, the aminotriazole-based compound, and the amino-containing triazine-based compound, since these compounds do not delay speed of curing of an addition-reaction-curable silicone composition which contains the organopolysiloxane having thermal-decomposition temperature increased by the method of the invention.

The hydrazine-based compound may comprise a diacyl hydrazide-based compound represented by general formula (1):

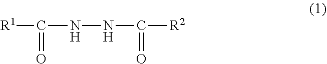

where R¹ and R² may be the same or different and may be represented by hydrogen atoms, hydroxyl groups, alkyl groups, substituted alkyl groups, aryl groups, phenol groups, or similar substituted aryl groups, aralkyl groups, or substituted aralkyl groups. It is preferable that R¹ and R² comprise monovalent hydrocarbon groups that contain aryl groups, or phenol groups or similar substituted aryl groups. More specific examples of the hydrazine-based compound are the following: N,N′-diformyl hydrazine, N,N′-diacetyl hydrazine, N,N′-dipropionyl hydrazine, N,N′-butylyl hydrazine, N-formyl-N′-acetyl hydrazine, N,N′-dibenzoyl hydrazine, N,N′-ditolyoyl hydrazine, N,N′-disalycyloyl hydrazine, N-formyl-N′-disalycyloyl hydrazine, N-formyl-N′-butyl-substituted salycyloyl hydrazine, N-acetyl-N′-salycyloyl hydrazine, N,N′-bis[3-(3,5-di-t-butyl-4-hydroxyphenyl)propyonyl]hydrazine, oxalic acid-di-(N′-salicyloyl)hydrazine, adipic acid di-(N′-salicyloyl)hydrazine, or dodecane dioyl-di-(n′-salicyloyl)hydrazine. Commercially produced compounds of the aforementioned type are the following: Irganox MD1024 (trademark of Ciba Specialty Chemicals Co., Ltd.): N,N′-bis-[3,5-di-t-butyl-4-hydroxyphenyl)propionyl]hydrazine), or Adekastab CDA-6 (trademark of Adeka Co., Ltd.; dodecanedioyl-di-(N′-salicyloyl) hydrazine).

The aminotriazole-based compound is expressed by the following general formula (2):

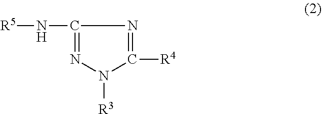

where R⁴ and R⁵ are the same or different and are represented by hydrogen atoms, alkyl groups, substituted alkyl groups, substituted aryl groups, carboxyl groups, acyl groups, alkyl-ester groups, halogens, aryl-ester groups, or alkali metals; R³ represents a hydrogen atom or an acyl group; R⁵ may be an acyl group and, preferably, salicyloyl, benzoyl, or a similar acyl group having an aromatic ring.

Specific examples of the aforementioned compounds are the following: 3-amino-1,2,4-triazole, 3-amino-1,2,4-triazole-carboxylic acid, 3-amino-5-methyl-1,2,4-triazol, 3-amino-5-heptyl-1,2,4-triazol, etc.; or an acid amide derivative of an amino-triazole-based compound where hydrogen atoms of a triazole-bonded amino groups are substituted with acyl groups, e.g., 3-(N-salicyloyl)amino-1,2,4-triazole or 3-(N-salicyloyl)-amino-5-methyl-1,2,4-triazol, 3-(n-acetyl)amino-12,4-triazol-5-carboxylic acid. Most preferable among the above compounds is the acid amide derivative of the aminotriazole-based compound since this compound does not delay speed of curing of an addition-reaction-curable silicone composition which contains the organopolysiloxane having thermal-decomposition temperature increased by the method of the invention. An example of a commercially produced compound of this type is Adekastab CDA-1 (trademark of Adeka Co., Ltd.: 3-(N-salicyloyl)amino-1,2,4-triazole).

The triazine-based compound can be exemplified by 1,3,5-triazine, 2,4,6-trihydroxy-1,3,5-triazine, 2,4,6-triamino-1,3,5-triazine. An example of a commercially available compound of this type is Adekastab ZS-27 (trademark of Adeka Co., Ltd.: main component is 2,4,6-triamino-1,3,5-triazine).

There are no special restrictions with regard to the amount in which metal deactivater (B) can be used, but it may be recommended to add this agent in the amount of 0.02 to 1 part by mass per 10 ppm of the alkali metal contained in component (A). If this agent is added in the amount of less than 0.02 parts by mass per 10 ppm of the alkali metal contained in component (A), the effect of improvement in heat-resistant properties may be insufficient. If, on the other hand, the amount of added component (B) is greater than 1 part by mass per 10 ppm of the alkali metal contained in component (A), this may lead to insufficient dispersion of component (B) in the organopolysiloxane.

The mixture of the invention is obtained by mixing the metal deactivater (B) with the organopolysiloxane (A) polymerized with the use of the alkali-metal catalyst. There are no special restrictions with regard to the equipment used for mixing. For example, mixing can be carried out by means of a Banbury mixer, a kneader mixer, a two-roll mill, a three-roll mill, a continuous-action kneader-extruder, planetary mixer, or other conventional mixing devices.

### EXAMPLES

The invention will be further described more specifically with reference to practical and comparative examples. It is understood that these examples should not be construed as limiting the scope of the invention. Concentration of potassium in the organopolysiloxane and 50% decomposition temperature were measured by the methods described below. All values of viscosity were measured at 25° C.

### <Potassium Concentration>

1 g of an organopolysiloxane sample was dosed into a Teflon® container, dissolved in 40 ml of hexane. Following this, 20 g of pure water were added, the contents were shaken, removed, and subjected to ion chromatography.

### <50% Decomposition Temperature>

20 mg of the obtained organopolysiloxane mixture of the invention were prepared, and change of mass was measured by means a thermogravimetric analyzer (TG-50, the product of Shimazu Co.) wherein the mixture was continuously heated from room temperature to 850° C. with a temperature increase rate of 15° C. per 1 min. The temperature at which decomposition and deterioration reached 50% of the mass was recorded as the 50% decomposition temperature the values of which are shown in Table 1.

### Preparation Example 1

A flask equipped with a mixer and a temperature-control device was loaded with the following components: 100 parts by mass of a cyclic dimethylpolysiloxane having a viscosity of 2.6 mm²/sec; 0.12 parts by mass of a dimethylpolysiloxane having viscosity of 5 mm²/sec and capped at both molecular terminals with trimethylsiloxy groups; and 0.09 parts by mass of a catalyst in the form of a potassium silanolate with a 3% content of potassium (30 ppm of potassium in the reaction mixture). The components were subjected to a polymerization reaction which was conducted at a temperature in the range of 165° C. to 170° C. until equilibrium was reached. Thereafter, the reaction product was neutralized by blowing an excessive amount of gaseous carbon dioxide into the flask. The product was then stripped by removing low-molecular-weight components under a reduced pressure of 20 mmHg and at a temperature ranging from 170° C. to 180° C. As a result, a dimethylpolysiloxane capped at both molecular terminals with trimethylsilyl groups was produced. Concentration of potassium in the product obtained by the above method was 31 ppm.

### Preparation Example 2

A flask equipped with a mixer and a temperature-control device was loaded with the following components: 99.82 parts by mass of a cyclic dimethylpolysiloxane having a viscosity of 2.6 mm²/sec; 0.18 parts by mass of a cyclic methylvinylpolysiloxane having viscosity of 3.1 mm²/sec; 0.10 parts by mass of a dimethylpolysiloxane having viscosity of 4.5 mm²/sec and capped at both molecular terminals with dimethylvinylsiloxy groups; and 0.09 parts by mass of a catalyst in the form of a potassium silanolate with a 3% content of potassium (30 ppm of potassium in the reaction mixture). The components were subjected to a polymerization reaction which was conducted at a temperature in the range of 165° C. to 170° C. until equilibrium was reached. The reaction product was then neutralized by blowing an excessive amount of gaseous carbon dioxide into the flask. The product was then stripped by removing low-molecular-weight components under reduced pressure of 20 mmHg and at a temperature ranging from 170° C. to 180° C. As a result, a copolymer of a dimethylsiloxane and a methylvinylsiloxane capped at both molecular terminals with dimethylvinylsiloxy groups was produced (content of vinyl groups: 0.065 mass %). Concentration of potassium in the product obtained by the above method was 35 ppm.

### Practical Examples 1 to 6, Comparative Examples 1 to 3

The organopolysiloxanes and the metal deactivaters taken in proportions shown in Table 1 were mixed to uniform mixture conditions in a kneader at room temperature. Following this, a 50% decomposition temperature of the obtained organopolysiloxane mixture was measured. Results of measurements are shown in Table 1.

TABLE 1

| | | | | | | | Comparative | | |
|---|---|---|---|---|---|---|---|---|---|
| | Practical Examples (Invention) | | | | | | Examples | | |
| | 1 | 2 | 3 | 4 | 5 | 6 | 1 | 2 | 3 |
| Organopolysiloxane (A) | | | | | | | | | |
| a-1 (parts by mass) | 100 | 100 | 100 | 100 | 100 | | 100 | 100 | |
| a-2 (parts by mass) | | | | | | 100 | | | 100 |
| Metal deactivater (B) | | | | | | | | | |
| b-1 (parts by mass) | 0.3 | 0.10 | | | | | | | |
| b-2 (parts by mass) | | | 0.3 | | | | | | |
| b-3 (parts by mass) | | | | 0.3 | | 0.3 | | 0.01 | |
| b-4 (parts by mass) | | | | | 0.3 | | | | |
| 50% decomposition | 385 | 392 | 489 | 488 | 417 | 439 | 328 | 356 | 317 |
| temperature (° C.) | | | | | | | | | |

Designations used in Tables 1 and 2 have the following meanings:

### <Component A: Organopolysiloxane>

a-1: dimethylpolysiloxane prepared in Preparation Example 1 and having both molecular terminals capped with trimethylsilyl groups; number-average molecular weight measured by gel-permeation chromatography (GPC) and recalculated to polystyrene was equal to 350,000.
a-2: a copolymer of a methylvinylsiloxane and a dimethylsiloxane prepared in Preparation Example 2 capped at both molecular terminals with dimethylvinylsiloxy groups (vinyl group content: 0.065 mass %); number-average molecular weight measured by gel-permeation chromatography (GPC) and recalculated to polystyrene was equal to 310,000.

### <Component B: Metal Deactivater>

b-1: Trademark-“Irganox” MD-1024:
N,N′-bis[3-(3,5-di-t-butyl-4-hydroxyphenyl)propionyl]hydrazine (the product of Ciba Specialty Chemicals Co., Ltd.)
b-2: trademark “Adekastab” CDA-1:
3-(N-salicyloyl)amino-1,2,4-triazole (the product of Adeka Co., Ltd.)
b-3: trademark “Adekastab” CDA-6:
dodecanedioyl-di-(N′-salicyloyl)hydrazine (the product of Adeka Co., Ltd.)
b-4: trademark “Adekastab” ZS-27:
a mixture the main component of which is 2,4,6-triamino-1,3,5-triazine (the product of Adeka Co., Ltd.)

### INDUSTRIAL APPLICABILITY

Since the organopolysiloxane mixture obtained by the method of the invention for improving thermal stability of the organopolysiloxane can be stripped at high temperatures, this mixture can be prepared with a reduced content of low-molecular-weight and low-boiling point components. This is in particular important for use of the organopolysiloxane mixture as a silicone oil in the field of electric and electronic devices and also as a raw material for a composition utilized in the manufacture, i.e., as silicone grease, silicone gel, silicone resin, silicone elastomer, or the like in the field of electric and electronic devices. Since the organopolysiloxane mixture has improved thermal stability, the organopolysiloxane mixture is preferable to use as a silicone oil and as a raw material for a composition utilized in the manufacture, i.e., as silicone grease, silicone gel, silicone resin, silicone elastomer, or the like for the application required high degree of heat-resistant properties or long term stability. Since the method of the invention makes it possible to eliminate the step of removal of neutralization salts of alkali-metal oxides, from the organopolysiloxane polymerized with participation of an alkali-metal catalyst, e.g., by filtering, this simplifies the manufacturing process of the organopolysiloxane.

1. A method of improving thermal stability of an organopolysiloxane by compounding a metal deactivater (B) selected from the group comprising a hydrazide-based compound, an oxalic-acid-based compound, an aminotriazole-based compound, a triazine-based compound, and a salicylidene-amine-based compound with an organopolysiloxane (A) polymerized with the use of an alkali metal catalyst.

2. The method of improving thermal stability of an organopolysiloxane according to claim 1, wherein the alkali metal catalyst is a potassium silanolate or potassium hydroxide.

3. The method of improving thermal stability of an organopolysiloxane according to claim 1, wherein component (B) is used in the amount of 0.02 to 1 part by mass per 10 ppm of the alkali metal contained in component (A).

4. The method of improving thermal stability of an organopolysiloxane according to claim 1, wherein the content of alkali metal in component (A) ranges from 1 to 500 ppm.

5. An organopolysiloxane mixture comprising an organopolysiloxane (A) polymerized with the use of an alkali metal catalyst and a metal deactivater (B) selected from the group comprising a hydrazide-based compound, an oxalic-acid-based compound, an aminotriazole-based compound, a triazine-based compound, and a salicylidene-amine-based compound.

6. The organopolysiloxane mixture of claim 5, wherein the alkali metal catalyst is a potassium silanolate or potassium hydroxide.

7. The organopolysiloxane mixture according to claim 5, wherein the content of the alkali metal in component (A) ranges from 1 to 500 ppm.

8. The method of improving thermal stability of an organopolysiloxane according to claim 2, wherein component (B) is used in the amount of 0.02 to 1 part by mass per 10 ppm of the alkali metal contained in component (A).

9. The method of improving thermal stability of an organopolysiloxane according to claim 2, wherein the content of alkali metal in component (A) ranges from 1 to 500 ppm.

10. The method of improving thermal stability of an organopolysiloxane according to claim 3, wherein the content of alkali metal in component (A) ranges from 1 to 500 ppm.

11. The method of improving thermal stability of an organopolysiloxane according to claim 1, wherein the metal deactivater (B) selected from the group comprising a hydrazide-based compound, an aminotriazole-based compound, and a triazine-based compound.

12. The method of improving thermal stability of an organopolysiloxane according to claim 1, wherein the metal deactivator (B) is a hydrazide-based compound.

13. The organopolysiloxane mixture of claim 5, wherein component (B) is used in the amount of 0.02 to 1 part by mass per 10 ppm of the alkali metal contained in component (A).
